(19) United States
(12) Patent Application Publication
(10) Pub. No.: US 2007/0261781 A1
(43) Pub. Date: Nov. 15, 2007

(54) FLEXIBLE FLUID-TRANSPORT DUCT PRESENTING REINFORCEMENT

(75) Inventors: Daniel Mahin, Savonnieres (FR); Marc Dolez, Olivet (FR); Pascal Oesterle, Nazelles-Negron (FR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Hutchinson

(21) Appl. No.: 11/745,578

(22) Filed: May 8, 2007

(30) Foreign Application Priority Data
May 12, 2006 (FR) 06 04231

(51) Int. Cl. B31C 13/00

(52) U.S. Cl. 156/184; 264/171.26; 428/36.1

(57) ABSTRACT

The invention relates to a flexible duct of elastomer for transferring fluid and presenting a reinforcing element, wherein said reinforcing element comprises at least one laid-in web. The invention also relates to a method of using elastomer to fabricate a flexible duct for transferring fluid, the duct presenting a reinforcing element, and wherein it implements laying at least one laid-in web on a forming cylinder that is optionally coated in elastomer material, and then covering the laid-in web(s) with an elastomer coating, and finally performing vulcanization.

The present invention relates to flexible elastomer ducts known as “hoses” that are for transporting fluids, in particular hot or cold air, or cooling liquids, and specifically in the environment of a car or truck engine, or an industrial installation.

### BACKGROUND OF THE INVENTION

Flexible ducts are usually reinforced by a tubular knit embedded in an elastomer. Such ducts are good at passing bends and they are more particularly adapted to applications that require a diameter that is relatively small (up to 50 millimeters (mm) to 60 mm) and pressures that are low, in particular because of the use of large-sized yarns and open-loop reinforcement. Such ducts also present the drawback of material swelling under pressure. From a method point of view, it should be observed that the tooling (knitting head) needs to be adapted to each range of diameters, and that it is difficult to obtain ducts having small wall thicknesses.

Another technique using a yarn covering provides good resistance to pressure and to deformation under pressure, but is limited to diameters that are even smaller (up to 30 mm to 35 mm).

A third technique consists in braiding yarns. It provides excellent resistance to pressure and a good range of diameters. However it requires a plurality of machines to be available in order to cover a large range of diameters. Finally, and above all, it is suitable only for making ducts having a large radius of curvature and of that flare little.

A fourth reinforcement technique makes use of a plane knit of the “lace” type, generally made from fine yarns on a knitting machine. The variety of mesh shapes provides a degree of control over longitudinal and transverse extensibility. That technique makes it possible to achieve some control over the problem of deformability under pressure, and it is suitable for making fluid-transport ducts of requested diameters.

An increase in performance is possible by implementing a plurality of radial layers, and it is possible to make parts presenting bends or flares.

That technique leads to costs that are rather high, and to mechanical performance that is rather poor, except when implementing multi-layer ducts (e.g. having 4 layers), which increases cost and interferes with controlling thickness.

A fifth technique makes use of a plane woven fabric obtained on a loom by crossing braided yarns, giving rise to little extensibility. The fabric is generally thin with braid openings that enable coating (rubberizing) to be performed during calandering.

For equal yarn weight, that technique leads to mechanical performance that is several times better than that of a knit, with rubberizing being easier and with it being possible to make walls of fine thicknesses is since there is no need to increase the number of reinforcing layers to such an extent.

That method is suitable for parts that are straight, and in particular for parts of the present corrugations. However it is expensive.

The fabric is a relatively undeformable. To remedy that, it is necessary to act on the angle at which it is cut (thus leading to large losses of material), or else to produce a tubular fabric at a fixed angle (45°).

Consequently, that method is not suitable for parts with bends, and it is therefore limited to simple straight parts, and to straight parts that are corrugated and/or slightly flared.

### OBJECTS AND SUMMARY OF THE INVENTION

An object of the present invention is to provide a flexible duct for fluid transfer that can be made at will in the form of corrugated and/or flared and/or bent sections, which, as explained above, is generally not possible with the techniques of the prior art.

Another object of the invention is to provide a flexible duct presenting large diameters (e.g. up to 50 centimeters (cm)).

The invention thus provides a flexible elastomer duct for transporting fluid that presents a reinforcing element, wherein said reinforcing element comprises at least one laid-in web.

The laid-in web is advantageously laid edge to edge, the axis of the web forming an angle θ with the axis of the duct.

The reinforcing element may comprise a pair of laid-in webs disposed edge to edge with opposite laying angles of θ and −θ. The angle θ lies for example in the range 30° to 70°, and more particularly in the range 30° to 54.7°.

The value of the angle is preferably substantially equal to θ₀=54.7° for a duct in the form of a straight section, thus enabling swelling under pressure to be minimized.

For a duct having at least one region with a bend or that is corrugated, or flared, the angle θ is preferably substantially equal to θ₀=54.7° in at least one said region in order to minimize swelling under pressure in that region.

The invention also provides a method of fabricating a flexible elastomer duct for transferring fluid, the duct presenting a reinforcing element, and wherein it implements laying at least one laid-in web on a forming cylinder, optionally coated in elastomer material, and then covering the laid-in web(s) by an elastomer coating, and finally performing vulcanization.

### BRIEF DESCRIPTION OF THE DRAWING

Other characteristics and advantages of the invention appear better on reading the following description, given by way of nonlimiting example and with reference to the drawing in which:

FIG. 1 shows a duct of the invention, with edge to edge winding;

FIG. 2 shows winding with overlap as in the prior art; and

FIGS. 3a to 3d show ducts of the invention that are straight, corrugated, flared, and/or with a bend.

### MORE DETAILED DESCRIPTION

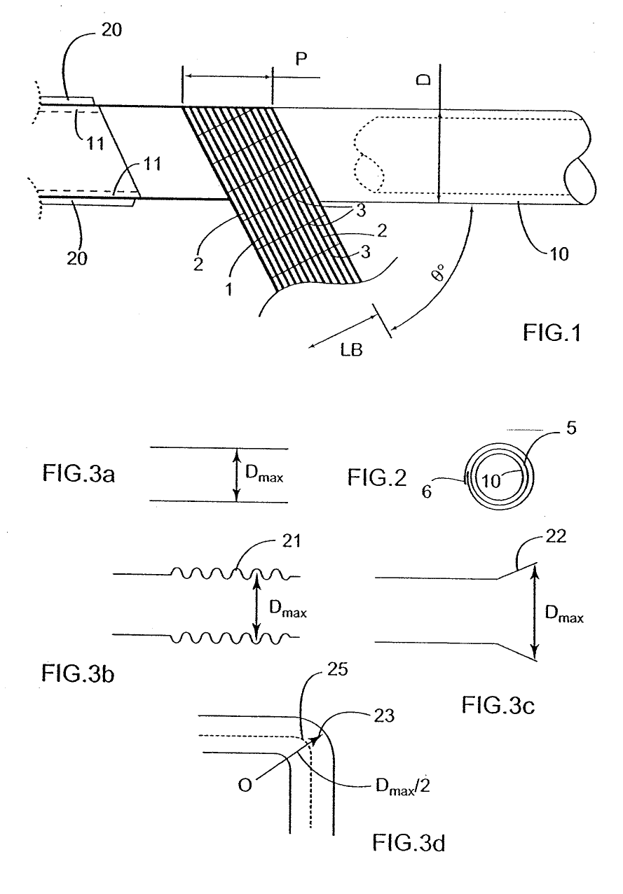

As shown in FIG. 1, a laid-in web 1 presenting warp yarns 2 and weft yarns 3 is laid edge to edge at a pitch P on a forming cylinder 10 of diameter D that is optionally coated in elastomer material 11, e.g. a silicone elastomer. The laying angle θₚ is the angle between the warp yarns 2 and the axis of the forming cylinder 10. The warp yarns and the weft yarns may be made of textile fibers, e.g. of polyester or of aramid fibers, or else they may be made of metal. Advantageously, at least two laid-in webs are laid with opposite laying angles θₚ.

The laying angle θₚ is selected to obtain a balance between the forces that result from pressure inside the duct, such that the flexible duct does not swell under pressure. Advantageously, this laying angle θₚ accommodates regions including bends, flares, and corrugations, in such a manner as to accommodate the corresponding maximum diameter Dₘₐₓ, as shown in FIGS. 3b to 3d, and in the manner described in the description below. For a straight duct, it is also possible to accommodate the fact that, following a shaping step, the diameter Dₘₐₓ of the finished product may be different from the diameter D obtained during forming on the cylinder 10.

The pitch P is selected in such a manner that laying takes place edge to edge, which means there is no loss of material as happens, for example, when winding braided fabric 5 (FIG. 2) presenting a limited and predetermined laying angle, with overlap 6 between edges parallel to the axis of the duct.

Preferably, two crossed laid-in webs are laid at two laying angles that are equal, but opposite, +θₚ and −θₚ.

Thereafter, the laid-in web(s) can be covered in an elastomer covering 20, e.g. a silicone elastomer covering, and the assembly is shaped in conventional manner to form, where appropriate, corrugations 21, and/or at least one bend 23, and/or at least one flare 22.

The duct is then vulcanized to set its shape and its mechanical characteristics.

In its final state, the hose may have a diameter Dₘₐₓ that is greater than the diameter D during forming on the forming cylinder 10. This is taken into account so that on the final duct of diameter Dₘₐₓ, the angle formed between the yarns 2 of the laid-in web and the axis of the formed a duct is equal to θ₀.

The laying angle θₚ may also be adapted to take account of the maximum diameter Dₘₐₓ corresponding to one or more zones, in which, during a shaping step, at least one bend, corrugations, and/or at least one flare is/are made in order to minimize deformability under pressure (FIG. 3b to 3d).

This adaptation is performed as follows:
tan θ₀=πDₘₐₓ/P with θ₀=54.7°, i.e.
cos θ₀=LB/πDₘₐₓ where LB=width of the laid-in web.

This gives a laying angle θₚ in the not yet shaped straight duct of diameter D:
tan θₚ=πD/P=D/Dₘₐₓ tan θ₀

Which means that the laying angle θₚ lies, in practice, in the range 30° to 70°, but is generally less than θ₀, and for example lies in the range 30° to 54.7°.

This formula is valid regardless of whether it is applied to straight ducts of diameter Dₘₐₓ other than D (and generally greater than D) or to ducts that are bent, corrugated, and/or flared, implying a value for Dₘₐₓ that is not equal to D (generally greater than D).

For a straight duct of diameter D that is conserved, the laying angle θₚ is naturally selected to be substantially equal to θ₀.

The duct of the invention presents cost that is considerably smaller than that of a duct based on woven fabric or on knitting, and it lends itself to obtaining much greater diameters than can be obtained with woven fabric. In addition, it lends itself to all types of outline (corrugations 21, and/or flare 22, and/or bends 23) and it lends itself naturally to making straight sections that are flexible or that are combined with sections having such outlines.

Controlling the laying angle makes it possible to optimize the deformability of the duct under pressure. For a duct presenting a plurality of zones, e.g. a bend and corrugations, the maximum value of Dₘₐₓ that is encountered is the value taken into account. In the region of a bend, the angle θ is taken between the direction of the warp yarns 2 and the tangent to the axis 25 of the bend.

The amount of material lost is small or nil, since the winding can be performed edge to edge.

There is also a saving in weight and an improvement in performance. Two crossed laid-in webs make it possible, for example, to obtain performance that corresponds to four knitted layers. Furthermore, laying can be performed automatically, thus leading to better quality.

Finally, dynamic performance is improved by the fact that there is no contact or crossing between yarns. Abrasion phenomena are thus limited or even nonexistent.

It will be understood that the angle θ₀ of 54.7° constitutes an optimum for opposing deformation of the duct under pressure. A value close to θ₀ (e.g. in the range 50° to 60°) can be used and satisfactory results will still be obtained.

What is claimed is:

1. A method of fabricating a flexible duct of elastomer for transferring fluid, the duct presenting a reinforcing element and involving laying at least one laid-in web on a forming cylinder optionally covered in an elastomer material, and then covering the laid-in web(s) with an elastomer covering, and finally performing vulcanization, wherein the duct is constituted by a straight section presenting an outside diameter D; wherein the method implements a shaping step to confer a diameter Dₘₐₓ other than D, possibly such that the duct presents at least one zone having corrugations, and/or at least one bend, and/or at least one flare, Dₘₐₓ then being the maximum diameter of the duct in said zone(s); and wherein the laying angle θₚ between the warp yarns of such a web relative to the axis of the duct is defined by:
tan θₚ=D/Dₘₐₓ tan θ₀
with θ₀ lying in the range 50° to 60°, and preferably being substantially equal to 54.7°.

2. A method according to claim 1, wherein at least one laid-in web is laid edge to edge, the warp yarns of said web forming a laying angle θₚ relative to the axis of the duct.

3. A method according to claim 2, wherein the reinforcing element comprises at least one pair of laid-in webs laid edge to edge with opposite laying angles of ±θₚ.

4. A method according to claim 3, wherein the laying angle θₚ lies in the range 30° to 70°, and more particularly in the range 30° to 54.7°.

5. A flexible elastomer duct in the non-shaped state for transferring fluid and presenting a reinforcing element comprising at least one laid-in web having warp yarns and an outside diameter D, wherein the duct is designed to present, in a shaped state, a diameter Dₘₐₓ not equal to D, possibly such that it presents in the shaped state at least one zone that is designed to be shaped so as to create corrugations, and/or at least one bend, and/or at least one flare, Dₘₐₓ then being the maximum diameter of the duct in said zone(s), and wherein the laying angle θₚ between the warp yarns relative to the axis of the duct is defined by:
tan θₚ=D/Dₘₐₓ tan θ₀
with θ₀ lying in the range 50° to 60°, and preferably being substantially equal to 54.7°.

6. A flexible duct according to claim 5, wherein the laid-in web is laid edge to edge, the axis of the warp yarns of the web forming said angle θₚ with the axis of the duct.

7. A flexible duct according to claim 5, wherein the reinforcing element comprises at least one pair of laid-in webs laid edge to edge with opposite laying angles of

8. A flexible duct according to claim 7, wherein the angle θₚ lies in the range 30° to 70°.

9. A flexible duct according to claim 8, wherein the angle θₚ lies in the range 30° to 54.7°.

10. A flexible duct made from a duct according to claim 5, including at least one region that is bent, corrugated, or flared, in which the angle θ between the axis of the warp yarns of the laid-in web and the axis of the duct is equal to θ₀.
